(19) United States
(12) Patent Application Publication
(10) Pub. No.: US 2024/0284564 A1
(43) Pub. Date: Aug. 22, 2024

(54) INDUCTION COOKING APPLIANCE

(71) Applicant: ELECTROLUX APPLIANCES AKTIEBOLAG, Stockholm (SE)

(72) Inventors: Alex VIROLI, Forli (IT); Massimo NOSTRO, Forli (IT); Massimo ZANGOLI, Forli (IT); Emanuel URGESE, Forli (IT); Alan MENGOZZI, Forli (IT); Adriano SCOTTO D'APOLLONIA, Forli (IT)

(21) Appl. No.: 18/570,725

(22) PCT Filed: May 23, 2022
(86) PCT No.: PCT/EP2022/063871

§ 371 Date: Dec. 15, 2023

(30) Foreign Application Priority Data
Jun. 15, 2021 (EP) 21179399.7

(51) Int. Cl. H05B 6/06; H05B 6/04; H05B 6/12

(52) U.S. Cl. CPC H05B 6/062; H05B 6/04; H05B 6/1218

(57) ABSTRACT

There is described an induction cooking appliance (1), in particular an induction cooking hob, for the thermal treatment of food products comprising at least a plurality of cooking zones (2) each having at least one induction coil (3) for generating an electromagnetic field and a power supply unit (9) coupled to the induction coils (3) and configured to selectively control an energy input into the induction coils (3). The power supply unit (9) comprises at least one quasi-resonant generator (14) coupled to at least one respective induction coil (3) and at least one half-bridge generator (15) being coupled to at least one respective induction coil (3).

The present invention relates to an induction cooking appliance, in particular an induction cooking hob, for the thermal treatment of food products.

Induction cooking appliances such as induction cooking hobs for the thermal treatment of food products are known household devices, which are conveniently efficient if compared with traditional gas or electric cooking appliances, because on the one side, they are accurate in controlling a cooking temperature and, on the other side, allow an uniform thermal treatment of the food product.

Induction cooking appliances typically comprise: a support plate provided with one or more cooking zones designed to heat loads, i.e. cooking vessels containing the food product, placed on the support plate. Each cooking zone comprises at least one induction coil for generating a time-varying electro-magnetic field inducing eddy currents in the loads.

Generally, the induction coils are selectively powered by means of a power unit. The power unit comprises a plurality of Quasi-resonant (QR) generators or a plurality of half-bridge generators (HB), each one operatively connected to at least one respective induction coil and configured to direct the required power to the respective induction coil.

While typically each QR generator comprises a respective single power switching device such as an IGBT-switch (acronym of Insulated Gate Bipolar Transistors), each half-bridge generator comprises two respective power switching devices.

It is known in the art, that while the QR generators are less complex in structure and are more economical, the half-bridge generators are more complex in structure and provide for better cooking performances and better cooking experiences to the users.

Thus, there are significant cost differences between these induction cooking appliances, which have a power unit equipped with QR-generators and the ones being equipped with half-bridge generators.

A need is felt in the sector to improve the known induction cooking appliances.

According to the present invention, there is provided an induction cooking appliance according to the independent claim.

Preferred non-limiting embodiments are claimed in the claims directly or indirectly depending on the independent claim.

In addition, according to the present invention, there is provided an induction cooking appliance, in particular an induction cooking hob, for the thermal treatment of food products comprising at least:
a plurality of cooking zones, each having at least one induction coil for generating an electromagnetic field; and
a power supply unit (operatively and/or electrically) coupled to the induction coils and configured to selectively control an energy input into the induction coils.

The power supply unit comprises:
at least one quasi-resonant generator (operatively and/or electrically) coupled to at least one respective induction coil; and
at least one half-bridge generator being (operatively and/or electrically) coupled to at least one respective induction coil.

In this manner, one obtains an induction cooking appliance being provided with both quasi-resonant and half-bridge generators. Therefore, on the one side one reduces the cost with respect to an induction cooking appliance being only provided with half-bridge generators on the other side, however, one also offers an induction cooking appliance having at least one cooking zone coming along with an increased cooking performance due to the respective half-bridge generator.

This is as the quasi-resonant generator has a lower cost than the half-bridge generator, but at the same time provides for lower cooking performances. In other words, while the quasi-resonant generator comes along with reduced costs, the half-bridge generator allows for better cooking performances.

Preferentially, each quasi-resonant generator is configured to (selectively) power and to control the respective at least one induction coil and to (selectively) control the respective electromagnetic field generated by the at least one induction coil. In particular, each quasi-resonant generator is configured to (selectively) control the respective energy supply to the respective at least one induction coil for (selectively) controlling the respective electromagnetic field.

Additionally, each half-bridge generator is configured to (selectively) power and control the respective at least one induction coil and to (selectively) control the respective electromagnetic field generated by the at least one induction coil. In particular, each half-bridge generator is configured to selectively control the respective energy supply to the respective at least one induction coil for controlling the respective electromagnetic field.

Preferentially, each quasi-resonant generator is not connected to and/or is not configured to control and power an induction coil, which may be connected to and/or controlled by and/or powered by a respective half-bridge generator

Preferentially, each half-bridge is not connected to and/or is not configured to control and power an induction coil, which may be connected to and/or controlled by and/or powered by a respective quasi-resonant generator

In particular, it should be noted that the term “to power and control” indicates that the respective quasi-resonant generator or the respective half-bridge generator can selectively modify the respective electromagnetic field.

According to some possible non-limiting embodiments, the power supply unit may comprise at least a plurality of quasi-resonant generators, each one (operatively and/or electrically) coupled to at least one respective induction coil, and in particular each one configured to (selectively) power and control the respective induction coil and to (selectively) control the respective electromagnetic field, even more particular to (selectively) control a respective energy supply for controlling the respective electromagnetic field.

In this way, it is possible to design induction cooking appliances having at least one half-bridge generator and to offer further low-cost cooking zones being controlled by means of quasi-resonant generators.

Alternatively or in addition, the power supply unit could comprise at least a plurality of half-bridge generators, each one (operatively and/or electrically) coupled to at least one respective induction coil, and in particular each one configured to (selectively) power and control the respective induction coil and to (selectively) control the respective electromagnetic field, even more particular to (selectively) control a respective energy supply for controlling the respective electromagnetic field.

In this way, it is possible to design induction cooking appliances having at least one quasi-resonant generator and to offer further high-performance cooking zones being controlled by means of respective half-bridge generators. In this way, it is possible to define an induction cooking appliance having the ideal cost-benefit ratio for varying kinds of users.

According to some possible non-limiting embodiments, each induction coil is adapted to deliver a respective maximum power. The at least one half-bridge generator is (operatively and/or electrically) coupled to the induction coil being adapted to deliver the largest respective maximum power, in particular so as to (selectively) power and to control the induction coil being adapted to deliver the largest respective maximum power. Additionally or alternatively, the at least one quasi-resonant generator is (operatively and/or electrically) coupled to the induction coil being adapted to deliver the lowest respective maximum power, in particular so as to (selectively) power and control the induction coil being adapted to deliver the lowest respective maximum power.

This is advantageous as the most power demanding induction coil is controlled by a half-bridge generator improving the user's cooking experience. It is in particular with respect to the most power demanding cooking zones, with which a consumer would more prominently experience a performance difference of the respective cooking zone when considering the control by means of a half-bridge generator and a quasi-resonant generator.

Alternatively or in addition, by associating the at least one quasi-resonant generator to the less power demanding induction coil one guarantees on the one side a lower cost and on the other side that the user does not experience significantly the difference between operation by means of a half-bridge generator and a quasi-resonant generator. Such a difference would be more prominent with higher power demanding induction coils.

Overall, one maximizes the cost-benefit relationship under consideration of the user experience.

According to some possible non-limiting embodiments, each induction coil is adapted to deliver a respective minimum power and a respective maximum power. At least one induction coil being coupled to one respective half-bridge generator presents a power difference between the respective minimum power and the respective maximum power being larger than the respective power differences between the respective minimum powers and the respective maximum powers of the other induction coils.

This allows to optimize the user experience.

According to some possible non-limiting embodiments, the induction cooking appliance may further comprise a signaling device for indicating a user the cooking zone to use in dependence of a specific cooking operation and/or cooking program to be executed. Preferentially, the signaling device may be configured to indicate in dependence of the specific cooking operation and/or cooking program the cooking zone to be used. In particular, the signaling device is configured to indicate a cooking zone, in dependence of a required cooking performance.

Preferentially, the signaling device is configured to indicate to a user the cooking zone having an induction coil being connected to, in particular powered by, the respective half-bridge generator or the respective quasi-resonant generator in dependence of a specific cooking operation and/or cooking program to be executed, in particular in dependence of the respective cooking performance to be achieved.

In this manner, it can be ensured that the user is directed to the most appropriate cooking zone, in particular when needing elevated cooking performance.

Preferentially but not necessarily, the signaling device may be configured to indicate the use of a cooking zone having an induction coil being coupled to, and in particular being, in use, (selectively) powered and controlled by, one respective half-bridge generator in dependence of the needed cooking performance, in particular if an elevated cooking performance is required.

An elevated cooking performance may be characterized by a precise and/or quick control of the respective induction coil and thereby a precise and/or quick control of the respective electromagnetic field. This is guaranteed if the respective induction coil is powered and controlled by a respective half-bridge generator.

In this manner, one guarantees the use of the cooking zone, whose induction coil is coupled to the half-bridge generator so as to guarantee the best cooking performance when such a cooking performance is required and/or at least advantageous.

According to some possible non-limiting alternatives, the signaling device is configured to indicate the use of a cooking zone having an induction coil being (operatively and/or electrically) coupled to, and in particular to be (selectively) powered and controlled, in use, by, one respective quasi-resonant generator in dependence of the needed cooking performance, in particular if a lower cooking performance is required.

This is advantageous so as to direct the user to a cooking zone having an induction coil coupled to a quasi-resonant generator, when the required cooking performance is less demanding.

According to some possible non-limiting embodiments, each quasi-resonant generator may comprise a respective quasi-resonant inverter circuit having a (single) power switching device, in particular a (single) Insulated Gate Bipolar Transistor.

The use of the (single) power switching device guarantees reduced costs of the quasi-resonant generator.

According to some possible non-limiting embodiments, each half-bridge generator may comprise a respective half-bridge inverter circuit having a plurality of power switching devices, in particular two power switching device, even more particular two single Insulated Gate Bipolar Transistors.

In this way, the control of the induction coil is improved with respect to a quasi-resonant generator and the overall cooking performance is increased.

According to some possible non-limiting embodiments, the power supply unit may comprise one or more microcontrollers configured to control operation of the least one quasi-resonant generator and the at least one half-bridge generator.

By providing for one or more microcontrollers it is possible to precisely operate the at least one quasi-resonant generator and the at least one half-bridge generator.

Preferentially but not necessarily, the power supply unit may comprise a plurality of drivers (operatively and/or electrically) coupled to the at least one quasi-resonant generator and the at least one half-bridge generator and one or more microcontrollers, each one (operatively and/or electrically) coupled to one or more respective drivers. Each microcontroller is configured to command the drivers for controlling operation of the at least one quasi-resonant generator and the at least one half-bridge generator, and in particular so as to (selectively) control the powering of the respective induction coils.

In this manner, a precise control of the operation of the half-bridge generator(s) and the quasi-resonant generator(s) is achieved.

According to some non-limiting embodiments, the power supply unit may comprise one or more power board assemblies coupled and/or coupleable to an external power supply and each carrying and/or comprising at least one quasi-resonant generator and/or at least one half-bridge generator.

Preferentially but not necessarily, each power board assembly may comprise a rectifier unit being coupled and/or coupleable to an external power supply and configured to convert an AC power signal provided by the external power supply into a rectified DC power signal. Each rectifier unit may be coupled to at least one quasi-resonant generator and/or to at least one half-bridge generator.

A non-limiting embodiment of the present invention will now be described, by way of example, with reference to the accompanying drawings, in which:

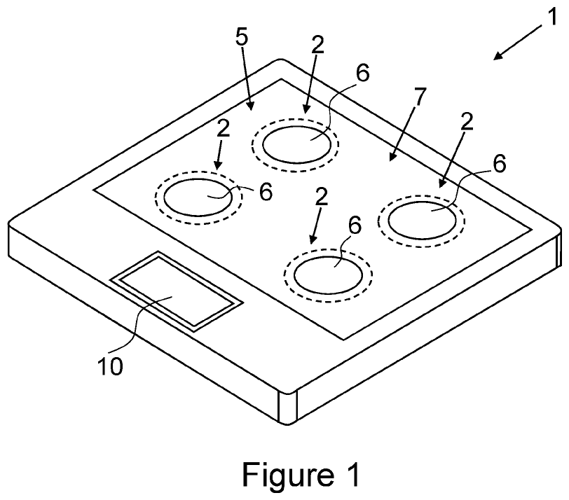

FIG. 1 is a schematic sketch of an induction cooking appliance according to the present invention, with parts removed for clarity;

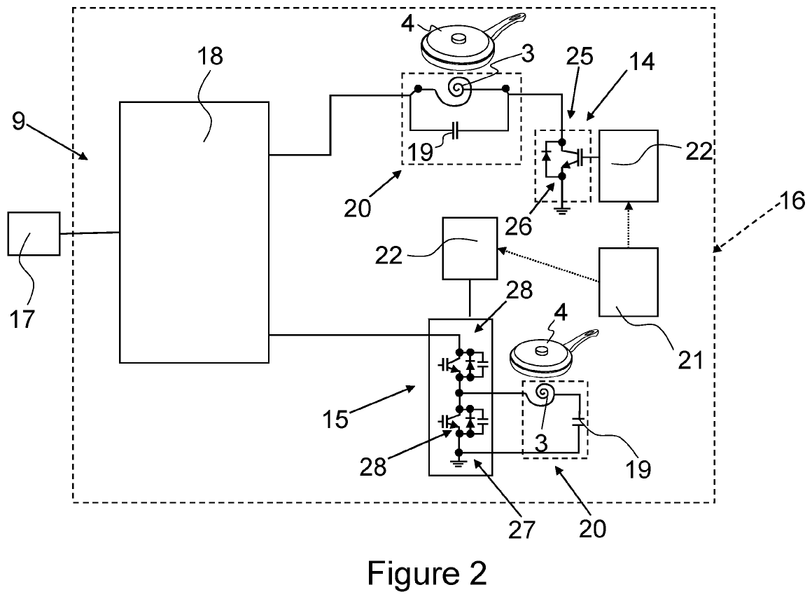

FIG. 2 is a schematic sketch of a portion of the induction cooking appliance of FIG. 1, with parts removed for clarity; and

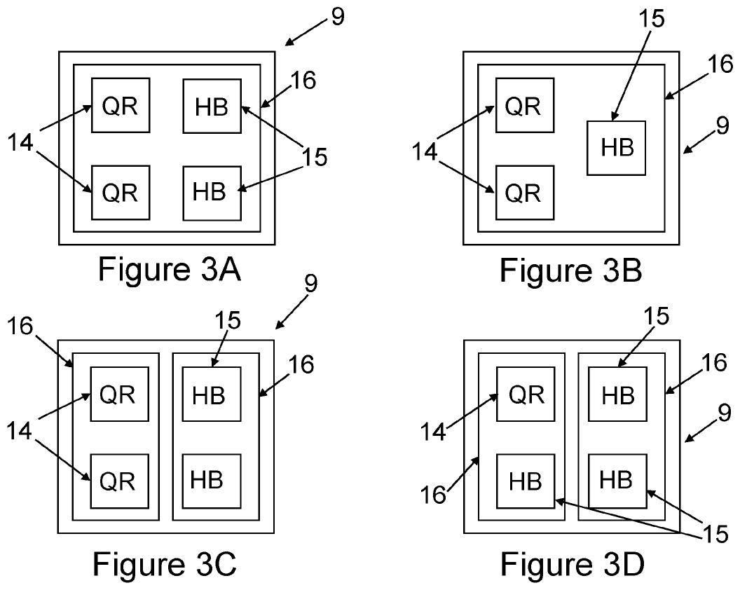

FIG. 3 are possible variations of the induction cooking appliance of FIG. 1, with parts removed for clarity.

With particular reference to FIGS. 1 and 2, number 1 indicates as a whole an induction cooking appliance, in particular an induction cooking hob, for the thermal treatment, in particular for the heating and/or cooking, of food products.

According to some possible non-limiting embodiments, the food product to be thermally treated may be a single ingredient or a mixture of ingredients. It should also be noted that the food product to be treated may vary throughout the overall thermal treatment process; i.e. it may be possible to add or remove ingredients to the food product during the thermal treatment.

Induction cooking appliance 1 comprises a plurality of cooking zones 2, each cooking zone 2 having at least one induction coil 3 configured to generate a respective (time-varying) electromagnetic field for heating a respective load, in particular a cooking vessel 4, even more particular a cooking vessel 4 being filled with the food product.

In particular, cooking vessel 4 is adapted to be heated by means of induction heating. Even more particular, cooking vessel 4 comprise (in particular substantially consist of) a magnetic and/or ferromagnetic material.

According to some possible non-limiting embodiments, each cooking vessel 4 can be of any type and form. A non-exhaustive list of cooking vessels 4 are pans, pots and kettles.

Furthermore, induction cooking appliance 1 may comprise a support plate 5, in particular having an horizontal orientation, comprising respective support portions 6 of cooking zones 2. In particular, support plate 5 is designed to carry cooking vessels 4.

Preferentially, each cooking zone 2 could comprise a respective support portion 6 and at least one induction coil 3 is associated to each support portion 6. In particular, each support portion 6 is configured to support the respective cooking vessel 4 to be heated by means of the respective induction coil 3.

More specifically, support plate 5 may comprise (in particular, consist of) a dielectric material, in particular a glass-ceramic material.

In particular, support plate 5 may comprise a first face 7 designed to carry cooking vessels 4 and a second face opposed to first face 6.

Moreover, induction coils 3 may be arranged such to face the second face. In particular, induction coils 3 may be arranged below support plate 5, in particular below the respective support portion 6.

Induction cooking appliance 1 also comprises a power supply unit 9 configured to selectively control an electrical energy input into induction coils 3.

Additionally, induction cooking appliance 1 may further comprise a user interface 10, in particular operatively coupled to power supply unit 9, designed to receive user input and/or providing information to the user. In particular, user interface 10 may be designed to receive user input relative to the energy input to be directed into induction coils 3. Even more particular, user interface 10 may be configured to receive a heating value/data indicative of a prefixed heating parameter, i.e. cooking temperature, selected by the user.

Advantageously, user interface 10 may be placed within a portion of support plate 5.

In more detail and with particular reference to FIGS. 2 and 3, power supply unit 9 may be configured to selectively control induction heating coils 3 by respective AC currents.

More specifically, power supply unit 9 comprises:
one or more Quasi-resonant generators 14, each one (operatively and/or electrically) coupled to at least one respective induction coil 3, and in particular to (selectively) power and control the respective at least one induction coil 3, even more particular to (selectively) power and control the respective at least one induction coil 3 and to control the respective electromagnetic field; and
one or more half-bridge generators 15, each one being (operatively and/or electrically) coupled to at least one respective induction coil 3, and in particular to (selectively) power and control the respective at least one induction coil 3, even more particular to (selectively) power and control the respective at least one induction coil 3 and to control the respective electromagnetic field.

Furthermore, each induction coil 3 may be adapted to deliver a power ranging between a respective maximum power and a respective minimum power. In particular, the respective maximum powers and the respective minimum powers may differ between at least some induction coils 3.

In particular, each induction coils 3 may have physical and/or structural properties determining the respective maximum power and the respective minimum power.

Accordingly, in the case of induction coils 3 having different physical and/or structural properties, the respective maximum powers and the respective minimum powers may differ from one another.

Each induction coil 3 is not be able to emit a power exceeding the respective maximum power and is not able to emit a power below the respective minimum power.

It should be noted that the minimum power is not the delivered power if the respective induction coil 3 is not powered, but is the minimum power when being powered (i.e. (electrical) energy is supplied to the respective induction coil 3; in other words, the respective quasi-resonant generator 14 or the respective half-bridge generator 15 is operated so as to provide for an energy supply above 0 kWh).

Moreover, at least one induction coil 3 may be adapted to deliver the largest maximum power; i.e. this induction coil 3 is adapted to deliver a maximum power larger than the maximum power of the others.

Additionally, at least one induction coil 3 may be adapted to deliver the lowest maximum power; i.e. this induction coil 3 is adapted to deliver a maximum power lower than the maximum power of the others.

In some cases, it is possible that some induction coils 3 present the same respective maximum power and/or the same respective minimum power.

According to some possible embodiments, at least one half-bridge generator 15 is (operatively and/or electrically) coupled to the induction coil 3 being adapted to deliver the largest respective maximum power, and in particular is also configured to (selectively) power and control the respective induction coil 3 being adapted to deliver the largest respective maximum power. In other words, the induction coil 3, which can be controlled to deliver the largest maximum power is controlled by means of one respective half-bridge generator 15. In the case that e.g. two induction coils 3 are adapted to deliver the same largest maximum power, at least one of these induction coils 3 is controlled by means of one respective half-bridge generator 15.

Alternatively and/or additionally, at least one quasi-resonant generator 14 is (operatively and/or electrically) coupled to the induction coil 3 being adapted to deliver the lowest respective maximum power, and in particular is also configured to (selectively) power and control the respective induction coil 3 being adapted to deliver the lowest respective maximum power. In other words, the induction coil 3, which can be controlled to deliver the lowest maximum power is controlled by means of one respective quasi-resonant generator 14. In the case that e.g. two induction coils 3 are adapted to deliver the same lowest maximum power, at least one of these induction coils 3 is controlled by means of one respective quasi-resonant generator 14.

According to some possible non-limiting embodiments, at least one induction coil 3 being coupled to one respective half-bridge generator 15 presents a power difference between the respective minimum power and the respective maximum power being larger than the respective power differences between the respective minimum powers and the respective maximum powers of the other induction coils 3. In particular, half-bridge generator 15 is configured to (selectively) power and control the induction coil 3, which presents a power difference between the respective minimum power and the respective maximum power being larger than the respective power differences between the respective minimum powers and the respective maximum powers of the other induction coils 3.

According to some possible non-limiting embodiments, induction cooking appliance 1 may further comprise a signaling device for indicating to a user which cooking zone 2 to use in dependence of a specific cooking operation and/or program to be executed.

More specifically, the signaling device may be configured to indicate the use of a cooking zone 3 having an induction coil 3 being (operatively and/or electrically) coupled to one respective half-bridge generator 15 in dependence of the needed cooking performance. E.g. in the case of a needed high cooking performance, the signaling device would indicate a cooking zone 3 being controlled by a half-bridge generator 15. E.g. half-bridge generator 15 allows for a more precise and/or quick control of the respective induction coil 3, in particular the respective energy supply into the respective induction coil 3. Additionally, a precise and/or quick control of the energy supply into the respective induction coil 3 allows to precisely and/or quickly controlling the heat within the respective cooking vessel 4.

Furthermore, the signaling device may also be designed to indicate the use of a cooking zone 2 having an induction coil 3 being (operatively and/or electrically) coupled to one respective quasi-resonant generator 14 in dependence of the needed cooking performance. E.g. the signaling device may be configured to indicate the quasi-resonant generator 14 if the control of the energy supply into the respective induction coil 3 does not need to come along with an elevated preciseness.

According to some possible embodiments, the signaling device may comprise light elements, each one associated to one respective cooking zone 2 and the signaling device being configured to turn on the light element associated to the cooking zone 2 to be used.

Alternatively or additionally, the signaling device may comprise a display for indicating the cooking zone 2 to be used.

In the specific examples shown in FIGS. 3A and 3C, power supply unit 9 comprises an equal number of quasi-resonant generators 14 and half-bridge generators 15, specifically two quasi-resonant generators 14 and two half-bridge generators 15.

Alternatively and with particular reference to FIGS. 3B and 3D, the respective number of quasi-resonant generators 14 and the respective number of half-bridge generators 15 may be different.

Furthermore, power supply unit 9 may comprise one or more power board assemblies 16, each one coupled and/or coupleable to an external power supply 17, such as a two phase (e.g. 220 volt) alternating current (AC) power supply. For example, external power supply 17 may be provided to a (residential) property from an energy production source such as an electric utility. It is understood that in addition and/or alternatively, any other external power source 17 can be used such as for example, a one phase (110V) power supply, or a three phase power supply (380 V) and/or a DC power source.

According to some possible non-limiting embodiments, power supply unit 9 may comprise at least two power board assemblies 16, and in particular at least one power board assembly 16 may be connected to a first phase and at least one other power board assembly 16 may be connected to a second phase of external power supply 17.

In more detail and with particular reference to FIG. 2, each power board assembly 16 may comprise a rectifier unit 18 coupled and/or coupleable to external power supply 17 and configured to convert an AC power signal provided by external power supply 17 into a rectified DC power signal. For example, each rectifier unit 18 may comprise a diode full-bridge for full-wave rectification or a synchronous rectifier with a plurality of switching elements for active rectification and/or any similar rectification circuit.

Furthermore, each power board assembly 16 may carry and/or comprise at least one quasi-resonant generator 14 and/or at least one half-bridge generator 15.

With particular reference to the variations shown in FIGS. 3A and 3B, power supply unit 9 may comprise a single power board assembly 16. According to such variations, the single power board assembly 16 comprises at least one quasi-resonant generator 14 and at least one half-bridge generator 15. Additionally, the single power board assembly 16 may comprise one or more further quasi-resonant generators 14 and/or one or more further half-bridge generators 15. In the specific variation shown in FIG. 3A, the single power assembly 16 comprises two quasi-resonant generators 14 and two half-bridge generators 15. In the specific variation of FIG. 3B, power board assembly 16 comprises two quasi-resonant generators 14 and one half-bridge generator 15.

With particular reference to the variations shown in FIGS. 3C and 3D, power supply unit 9 may comprise two power board assemblies 16. Each power board assembly 16 may comprise either one or more quasi-resonant generators 14 or one or more half-bridge generators 15. In the variation shown in FIG. 3C, one power board assembly 16 comprises two quasi-resonant generators 14 and the other power board assembly 16 comprises two half-bridge generators 15. In the variation shown in FIG. 3D, one power board assembly 16 comprises one quasi-resonant generator 14 and one half-bridge generator 15 and the other power board assembly 16 comprises two half-bridge generators 15.

It is clear that other variations can originate from the general concept that power supply unit 9 comprises at least one half-bridge generator 15 and at least one quasi-resonant generator 14. In other words, each power board assembly 16 can be equipped with one or more quasi-resonant generators 14 and/or half-bridge generators 15 such that power supply unit 9 comprises at least one half-bridge generator 15 and at least one quasi-resonant generator 14.

With particular reference to FIG. 2, power supply unit 9 may comprise a plurality of resonant capacitors 19, each one associated to one respective induction coil 3 so as to form in combination a respective resonator tank 20.

With particular reference to FIG. 2, each rectifier unit 18 is electrically connected and/or connectable to one or more quasi-resonant generators 14 and/or one or more half-bridge generators 15 and/or induction coils 3 and/or resonant capacitors 19.

Moreover, power supply unit 9 may comprise one or more microcontrollers 21 configured to selectively control operation of quasi-resonant generators 14 and half-bridge generators 15, in particular such that quasi-resonant generators 14 and half-bridge generators 15 can selectively power and control the respective induction coils 3, even more particular so as to selectively control the respective electromagnetic field.

In particular, each power board assembly 16 comprises one respective microcontroller 21, the respective microcontroller 21 being configured to selectively control the respective quasi-resonant generators 14 and/or the respective half-bridge generators 15. In other words, the respective quasi-resonant generators 14 and/or the respective half-bridge generators 15 of each power board assembly 16 are selectively controlled by means of the respective microcontroller 21, in particular such that quasi-resonant generators 14 and half-bridge generators 15 can selectively power and control the respective induction coils 3.

Additionally, power supply unit 9 comprises, in particular power board assemblies 16 comprise, a plurality of drivers 22, each one (operatively and/or electrically) coupled to a respective quasi-resonant generator 14 or a respective half-bridge generator 15 and to one respective microcontroller 21.

Moreover, each microcontroller 21 may be configured to selectively command the respective drivers 22 for selectively controlling the respective quasi-resonant generator 14 or the respective half-bridge generator 15.

It should be noted that the drivers 22 associated to quasi-resonant generators 14 may be (with regard to their construction) different to the drivers 22 associated to half-bridge generator 15. In particular, the drivers 22 associated to quasi-resonant generators 14 may be less complex (and consequently less expensive) than the drivers 22 associated to half-bridge generators 15.

In further detail and with particular reference to FIG. 2, each quasi-resonant generator 14 comprises a respective quasi-resonant inverter circuit 25 having a power switching device 26, in particular an Insulated Gate Bipolar Transistor.

According to the non-limiting embodiment shown, each quasi-resonant generator 14 could comprise a single power switching device 26, in particular a single Insulated Gate Bipolar Transistor.

Alternatively, each quasi-resonant generator 14 could comprise two parallelly arranged power switching devices 26, in particular two parallelly arranged Insulated Gate Bipolar Transistors.

More specifically, each power switching device 26 may be connected to the respective driver 22 for controlling the respective power switching device 26.

In further detail and with particular reference to FIG. 2, each half-bridge generator 15 may comprise a respective half-bridge inverter circuit 27 having a plurality of power switching devices 28, in particular two power switching device 28, even more particular two single Insulated Gate Bipolar Transistors.

More specifically, each plurality of power switching devices 28 may be connected to the respective driver 22 for controlling operation of the respective plurality of power switching devices 28.

In use, a user places one or more cooking vessels 4 on respective cooking zones 2 and power supply unit 9 controls the energy supply to induction coils 3 for generating the heat within the respective cooking vessel 4.

Clearly, changes may be made to induction cooking appliance 1 without, however, departing from the scope of the present invention.

### LIST OF REFERENCE SIGNS

1 Induction cooking appliance
2 Cooking zone
3 Induction coil
5 Support plate
6 Support portion
7 First face
9 Power supply unit
10 User interface
14 Quasi-resonant generator
15 Half-bridge generator
16 Power board assembly
17 External power supply
18 Rectifier unit
19 Capacitors
20 Resonator tank
21 Microcontroller
22 Drivers
25 Quasi-resonant inverter circuit
26 Single power switching device
27 Half-bridge inverter circuit
28 Power switching device

1. Induction cooking appliance, comprising:
a plurality of cooking zones each having an induction coil for generating an electromagnetic field; and
a power supply unit coupled to the induction coils and configured to selectively control an energy input into the induction coils;
wherein the power supply unit comprises:
a quasi-resonant generator coupled to at least one respective induction coil, and configured to power and control the at least one respective induction coil for controlling the respective generated electromagnetic field; and
a half-bridge generator being coupled to at least one respective induction coil, and configured to power and control the at least one respective induction coil for controlling the respective generated electromagnetic field.

2. Induction cooking appliance according to claim 1, wherein the power supply unit comprises a plurality of quasi-resonant generators, each one coupled to at least one respective induction coil, and configured to power and control the respective induction coil(s) for controlling the respective electromagnetic field.

3. Induction cooking appliance according to claim 1, wherein the power supply unit comprises a plurality of half-bridge generators, each one coupled to at least one respective induction coil, and configured to power and control the respective induction coil for controlling the respective electromagnetic field.

4. Induction cooking appliance according to claim 1, wherein each induction coil is adapted to deliver a respective maximum power;
wherein the half-bridge generator is coupled to the induction coil adapted to deliver the largest respective maximum power, and is configured to power and control the induction coil adapted to deliver the largest respective maximum power; and/or wherein the quasi-resonant generator is coupled to the induction coil adapted to deliver the lowest respective maximum power, and is configured to power and control the induction coil adapted to deliver the lowest respective maximum power.

5. Induction cooking appliance according to claim 1, wherein each induction coil is adapted to deliver a respective minimum power and a respective maximum power;
at least one induction coil being coupled to one respective half-bridge generator presents a power difference between the respective minimum power and the respective maximum power being larger than the respective power differences between the respective minimum powers and the respective maximum powers of the other induction coils.

6. Induction cooking appliance according to claim 1, further comprising a signaling device configured to indicate to a user the cooking zone to use in dependence of a specific cooking operation and/or cooking program to be executed.

7. Induction cooking appliance according to claim 6, wherein the signaling device is configured to indicate the use of a said cooking zone having an induction coil being coupled to one respective half-bridge generator in dependence of needed cooking performance.

8. Induction cooking appliance according to claim 6, wherein the signaling device is configured to indicate the use of a said cooking zone having an induction coil being coupled to one respective quasi-resonant generator in dependence of needed cooking performance.

9. Induction cooking appliance according to claim 1, wherein said quasi-resonant generator comprising a quasi-resonant inverter circuit having a power switching device.

10. Induction cooking appliance according to claim 1, wherein said half-bridge generator comprises a half-bridge inverter circuit having a plurality of power switching device.

11. Induction cooking appliance according to claim 1, wherein the power supply unit comprises a microcontrollers configured to control operation of the quasi-resonant generator and the half-bridge generator.

12. Induction cooking appliance according to claim 1, wherein the power supply unit comprises a plurality of drivers coupled to the quasi-resonant generator and the half-bridge generator and one or more microcontrollers, each one coupled to one or more respective drivers;
wherein each microcontroller is configured to command the drivers for controlling operation of the quasi-resonant generator and the half-bridge generator.

13. Induction cooking appliance according to claim 1, wherein the power supply unit comprises one or more power board assemblies coupled and/or coupleable to an external power supply and each carrying and/or comprising at least one quasi-resonant generator and/or at least one half-bridge generator.

14. Induction cooking appliance according to claim 13, wherein each power board assembly comprises a rectifier unit being coupled and/or coupleable to the external power supply and configured to convert an AC power signal provided by the external power supply into a rectified DC power signal;
wherein each rectifier unit is coupled to at least one quasi-resonant generator and/or to at least half-bridge generator.

15. Induction cooking appliance comprising:
first and second cooking zones having associated therewith first and second induction coils, respectively, each adapted to generate an electromagnetic field for heating food;
a power supply unit comprising a quasi-resonant generator coupled to and configured to power and control the first induction coil to generate the associated electromagnetic field, and a half-bridge generator coupled to and configured to power and control the second induction coil to generate the associated electromagnetic field, wherein the quasi-resonant generator is not coupled to the second induction coil to power and control the same, and the half-bridge generator is not coupled to the first induction coil to power and control the same; and
a signaling device adapted to provide an indication to a user that the second cooking zone, having associated therewith the second induction coil, is to be used in dependence on a specific cooking operation or cooking program requiring elevated cooking performance that cannot be achieved by the quasi-resonant generator powering and controlling the first induction coil.

16. The induction cooking appliance according to claim 15, said second induction coil being adapted to deliver the largest maximum power in operation compared to all induction coils of the appliance, and said first induction coil being adapted to deliver the lowest maximum power in operation compared to all induction coils of the appliance.

17. The induction cooking appliance according to claim 15, said power supply unit comprising a power board assembly adapted to be coupled to an external power supply, the power board assembly comprising both the quasi-resonant generator and the half-bridge generator, and a microcontroller configured to selectively control their operation.

18. The induction cooking appliance according to claim 16, further comprising third and fourth cooking zones having associated therewith third and fourth induction coils, respectively, each adapted to generate an electromagnetic field for heating food;
said quasi-resonant generator being coupled to and configured to power and control the third induction coil to generate the associated electromagnetic field, and said half-bridge generator coupled to and configured to power and control the fourth induction coil to generate the associated electromagnetic field.
